(19) United States
(12) Patent Application Publication
(10) Pub. No.: US 2018/0218848 A1
(43) Pub. Date: Aug. 2, 2018

(54) SUPERCAPACITORS CONTAINING CARBON BLACK PARTICLES

(71) Applicant: Cabot Corporation, Boston, MA (US)

(72) Inventors: Aurelien L. DuPasquier, Westford, MA (US); Jeffrey Scott Sawrey, Westford, MA (US); Derek Li, Acton, MA (US); Paolina Atanassova, Waltham, MA (US); Miodrag Oljaca, Concord, MA (US)

(21) Appl. No.: 15/877,431

(22) Filed: Jan. 23, 2018

Related U.S. Application Data
(60) Provisional application No. 62/451,171, filed on Jan. 27, 2017.

(51) Int. Cl. H01G 11/42; H01G 11/38; H01G 11/24; H01G 11/52; H01G 11/68

(52) U.S. Cl. CPC H01G 11/42; H01G 11/38; H01G 11/68; H01G 11/52; H01G 11/24

(57) ABSTRACT

A supercapacitor includes an electrode comprising activated carbon and carbon black particles containing less than or equal to about 100 ppm of calcium. A method includes treating base carbon black particles to form treated carbon black particles containing less than or equal to about 100 ppm of calcium; and using the treated carbon black particles to form an electrode of a supercapacitor. Carbon black particles having a Brunauer, Emmett and Teller (BET) surface area ranging from 650 m²/g to 2,050 m²/g, and comprising less than or equal to about 100 ppm of calcium.

### CROSS REFERENCE TO RELATED APPLICATION

This application claims the benefit of U.S. Provisional Application No. 62/451,171, filed on Jan. 27, 2017, hereby incorporated by reference.

### FIELD OF THE INVENTION

The invention relates to supercapacitors including carbon black particles and related methods.

### BACKGROUND

Supercapacitors, also known as electrochemical capacitors, electrochemical double layer capacitors, and ultracapacitors, are types of energy storage devices, like batteries and fuel cells. In a conventional capacitor, energy is stored by the removal of charge carriers, typically electrons, from one metal plate and depositing them on another. This charge separation creates a potential between the two plates, which can be harnessed in an external circuit. In contrast to conventional capacitors, supercapacitors typically do not have a conventional dielectric. Rather than two separate plates separated by an intervening substance, supercapacitors can use “plates” that are in fact two layers of the same substrate, and their electrical properties, the so-called “electrical double layer”, result in the effective separation of charge despite the very thin (e.g., on the order of nanometers) physical separation of the layers. The lack of need for a bulky layer of dielectric permits the packing of “plates” with much larger surface area into a given size, resulting in very high capacitances in practical sized packages.

Fabrication of supercapacitors typically includes forming a porous body layer, also known as an electrode membrane or electrode membrane layer (or simply referred to herein as an “electrode”), on a current collector, usually aluminum or another conductive substrate. Both electrode and current collector have electronic conductivity. The electrode is generally formed by applying a solvent containing a dispersion or slurry that contains porous carbonaceous particles, which is usually micron-sized activated carbon particles with a conductive additive, which is also usually a carbonaceous material, a binder, and a solvent onto the collector. Alternative methods exist that include a dry extrusion process and pressing or compacting the dry materials together. The final electrode may contain about 80-95 wt % of activated carbon, about 5-20 wt % of conductive additive, and some polymeric binder. The conductive additive in the electrode is used to give sufficient electronic conductivity to the electrode as well as to eliminate the “dead” space, which otherwise had to be filled with an electrolyte.

Various studies have been performed to better understand the effect of material properties on performance. In general, supercapacitors with lower internal resistance (or Equivalent Series Resistance (ESR)) and a high volumetric capacitance (electrical capacitance per unit volume) are desired. The volumetric capacitance is defined as the electrical capacitance of material per unit mass, also known as gravimetric capacitance (a value in Farads per gram), multiplied by the density of electrode (a value in grams per cubic centimeter). The capacitance in general increases with increasing the surface area of the carbon material. By adjusting the content of the conductive additive in the electrode, the electronic part of the ESR can be tuned.

### SUMMARY

In one aspect, the invention features supercapacitors having one or more electrodes including carbon black particles as a conductive additive that lowers the internal resistance of the electrodes. The carbon black particles have one or more characteristics (such as high surface area, low structure, low levels of certain elements, and small particle size distribution) that enhance the performance of the supercapacitors. For example, it is believed that the high surface areas of the carbon black particles provide the supercapacitors with low ESR and high volumetric and gravimetric capacitance. The low levels of certain elements (such as calcium, potassium, sodium, and others) can reduce side reactions that cause self-discharge, generate gassing and degrade the cycle-life performance of the supercapacitors, particularly at elevated temperatures and high voltages. The small particle size distributions of the carbon black particles enable fabrication of tightly-packed, thin, and highly dense electrodes, which have lower ESRs than thicker electrodes.

In another aspect, the invention features a supercapacitor including an electrode including activated carbon and carbon black particles having less than or equal to about 100 ppm of calcium.

In another aspect, the invention features a method including treating base carbon black particles to form treated carbon black particles having less than or equal to about 100 ppm of calcium; and using the treated carbon black particles to form an electrode of a supercapacitor.

In another aspect, the invention features carbon black particles having a Brunauer, Emmett and Teller (BET) surface area ranging from about 600 m²/g to about 2,100 m²/g, and comprising less than or equal to about 100 ppm of calcium.

In another aspect, the invention features a supercapacitor including an electrode including carbon black particles having less than or equal to about 100 ppm of calcium.

Embodiments of one or more aspects may include one or more of the following features. The carbon black particles further include less than or equal to about 100 ppm of potassium and/or less than or equal to about 100 ppm of sodium. The carbon black particles include one or more of the following characteristics: less than or equal to about 30 ppm of iron; less than or equal to about 2 ppm of nickel; less than or equal to about 2 ppm of copper; less than or equal to about 2 ppm of lead; and/or less than or equal to about 2 ppm of manganese. The carbon black particles have a Brunauer, Emmett and Teller (BET) surface area ranging from about 600 m²/g to about 2,100 m²/g, e.g., from about 750 m²/g to about 1500 m²/g. The carbon black particles have a crushed dibutyl phthalate (CDBP) value ranging from about 50 mL/100 g to about 300 mL/100 g, e.g., from about 200 mL/100 g to about 300 mL/100 g. The carbon black particles have a D₅₀ agglomerate particle size distribution of less than about 50 micrometers, and/or a D₉₅ agglomerate particle size distribution of less than about 250 micrometers. The carbon black particles comprise one or more of the following characteristics: an average primary particle size of from about 8 nm to about 50 nm; an average aggregate particle size of from about 50 nm to about 500 nm; an iodine number value of from about 1,000 mg/g to about 2,200 mg/g; an ash content of less than about 0.5 wt %; and/or a pH of about 3 to about 7. The ratio of carbon black particles to activated carbon ranges from about 1:99 to about 15:85. The activated carbon has a BET surface area ranging from about 1,000 m²/g to about 2,500 m²/g. The supercapacitor of any one of the preceding claims, wherein the activated carbon has pore volume equal to or greater than about 0.7 cm³/gram and/or a microporosity equal to or greater than 60%.

The activated carbon can include one or more of the following characteristics: less than or equal to about 100 ppm of calcium; less than or equal to about 100 ppm of potassium; less than or equal to about 100 ppm of sodium; less than or equal to about 30 ppm of iron; less than or equal to about 2 ppm of nickel; less than or equal to about 2 ppm of copper; less than or equal to about 2 ppm of lead; and/or less than or equal to about 2 ppm of manganese.

The supercapacitor can be a pseudo-capacitor or a hybrid supercapacitor.

Treating the base carbon black particles can include contacting the base carbon black particles with an acid, such as hydrochloric acid, nitric acid, citric acid, formic acid, acetic acid, and oxalic acid.

The method can further include using activated carbon to form the electrode.

The activated carbon can include one or more of the following characteristics: less than or equal to about 100 ppm of calcium; less than or equal to about 100 ppm of potassium; less than or equal to about 100 ppm of sodium; less than or equal to about 30 ppm of iron; less than or equal to about 2 ppm of nickel; less than or equal to about 2 ppm of copper; less than or equal to about 2 ppm of lead; and/or less than or equal to about 2 ppm of manganese.

Other aspects, features, and advantages of the invention will be apparent from the description of the embodiments thereof and from the claims.

### BRIEF DESCRIPTION OF THE DRAWINGS

FIG. 1 is cross-sectional view of an electrochemical double layer capacitor that comprises a carbon black.

FIG. 2 is a plot of specific capacitance (F/g) vs. voltage (V) for supercapacitor electrodes with different compositions.

FIG. 3 is a plot of capacity retention (%) vs. number of cycles for supercapacitor electrodes with different compositions.

FIG. 4 is a plot of specific capacitance (F/g) vs. current density (A/g) for supercapacitor electrodes with different compositions.

FIGS. 5(a), 5(b) and 5(c) are Nyquist plots of two-electrode EDLCs with different compositions in the frequency range between 1 MHz and 10 mHz for pristine cells (FIG. 5(a)), cells after the rate capability test (FIG. 5(b)), and cells after long cycling (FIG. 5(c)).

### DETAILED DESCRIPTION OF THE EMBODIMENTS

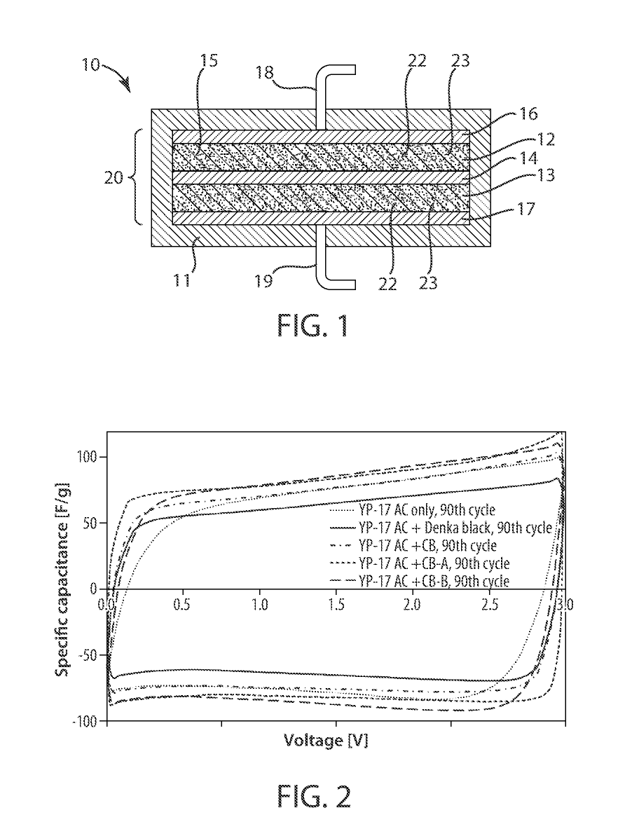

Referring to FIG. 1, an electrochemical double layer capacitor (EDLC) 10 is shown that includes the present carbon black particles. EDLC 10 has nonconductive enclosing body 11, a pair of carbon electrodes 12 and 13, an electronic porous separator layer 14, an electrolyte 15, a pair of conductive layers which are current collectors 16 and 17 and electrical leads 18 and 19, extending from the current collectors 16 and 17. One of the pair of current collectors 16 and 17 is attached to the back of each electrode 12 and 13. Electrodes 12 and 13 can each represent a plurality of electrodes so long as the electrodes are porous to electrolyte flow. Electrodes 12 and 13 can be, for example, carbon powder electrodes, activated carbon powder electrodes, or combinations of both, which comprise the present carbon black particles. One or both of electrodes 12 and 13 can include a matrix including polymeric binder 22 and carbon powder 23, which are indicated for illustration only here and are not drawn to scale. As indicated, the electrode can be formed, for example, from a dispersion formulation comprising polymer binder, the carbon black particles (with or without activated carbon powder), and solvent, which can be applied in slurry form on the current collectors. As indicated, current collectors 16 and 17 can be, for example, thin layers of aluminum foil, or other suitable conductive materials. Electronic separator 14 is placed between opposing carbon electrodes 13 and 14. Electronic separator 14 can be, for example, made from a porous material that acts as an electronic insulator between carbon electrodes 12 and 13. Separator 14 keeps opposing electrodes 12 and 13 out of contact with one another. Contact between electrodes 12 and 13 could result in a short circuit and rapid depletion of the charges stored in the electrodes. The porous nature of separator 14 allows movement of ions in electrolyte 15. In those embodiments in which the separator layers can be in contact with sealant material, they can have a porosity sufficient to permit the passage of sealant and can be resistant to the chemical components in the sealant. Enclosing body 11 can be, for example, any known enclosure means commonly used with or suitable for EDLCs. EDLC 10 can have a bipolar double layer cell 20 comprising the indicated features. EDLC cells comprising the present carbon black particles can be stacked in series (not shown), such as in conventional arrangements useful for this purpose. One or more EDLC cells including the present carbon black particles also can be used in combination with cells containing different carbon blacks or other conductive powders or materials.

The present carbon black particles are selected to have one or more properties, in any combination, that help to enhance the performance of EDLC 10. These properties include: high surface areas, low structures, low concentrations of selected elements (such as calcium, sodium and potassium), and small and controlled particle size distributions.

Without being bound by any theory, it is believed that the high surface areas of the carbon black particles provide ELCD 10 with low ESR and high volumetric and gravimetric capacitance. In some embodiments, the present carbon black particles have a nitrogen BET surface area from about 600 m²/g to about 2,100 m²/g, or higher. The nitrogen BET surface area can have or include, for example, one of the following ranges: from about 600 to about 2,100 m²/g, or from about 650 to about 2,050 m²/g, or from about 600 to about 2,000 m²/g, or from about 650 to about 1,950 m²/g, or from about 700 to about 1,900 m²/g, or from about 750 to about 1,500 m²/g, or from about 750 to about 1,850 m²/g, or from about 800 to about 1,800 m²/g, or from about 850 to about 1,750 m²/g, or from about 900 to about 1,700 m²/g, about 950 to about 1,650 m²/g; or about 1,000 to about 1,600 m²/g, or from about 1,050 to about 1,550 m²/g, or from about 1,100 to about 1,500 m²/g, or from about 1,150 to about 1,450 m²/g, or from about 1,200 to about 1,400 m²/g, or from about 1,250 to about 1,350 m²/g, or from about 1,275 to about 1,325 m²/g, or about 1,275 to about 1,300 m²/g. Other ranges within or outside of these ranges are possible. All BET surface area values disclosed herein refer to “nitrogen BET surface area” and are determined by ASTM D6556-04, the entirety of which is incorporated herein by reference.

In some embodiments, the average BET surface area of the present carbon black particles (BET_{CB}) is similar to the average BET surface area of the activated carbon (BET_{AC}), for example, so that the carbon black particles can provided EDLC 10 with low ESR and high volumetric and gravimetric capacitance. The ratio of BET_{CB}:BET_{AC} can range, for example from about 0.8: about 1 (e.g., about 0.88:about 1, or about 0.9:about 1, or about 0.95:about 1).

The low structures of the carbon black particles, as denoted by their CDBP values, are believed to enhance packing of the particles, for example, to form a dense and thin (e.g., less than about 10 micrometers) electrode having high volumetric capacitance and/or low ESR. In certain embodiments, the present carbon black particles have a crushed dibutyl phthalate (CDBP) value the range of from about 50 to about 300 mL/100 g, or from about 60 to about 290 mL/100 g, or from about 70 to about 280 mL/100 g, or from about 80 to about 270 mL/100 g, or from about 90 to about 260 mL/100 g, or from about 100 to about 250 mL/100 g, or from about 110 to about 240 mL/100 g, or from about 120 to about 230 mL/100 g, or from about 130 to about 220 mL/100 g, or from about 140 to about 210 mL/100 g, or from about 150 to about 200 mL/100 g, or from about 160 to about 190 mL/100 g, or from about 170 to about 180 mL/100 g or from about 200 to about 300 mL/100 g,. Other ranges within or outside of these ranges are possible. The CDBP value is the dibutyl phthalate adsorption (DBPA) value for the carbon black particles determined after controlled compression, expressed as milliliters of DBPA per 100 grams compressed carbon black particles. The CDBP value is also known as crushed oil adsorption number (COAN). As used herein, except as otherwise noted, the CDBP value is based upon ASTM Standard D3493-06 in modified form. For purposes herein, the procedure of ASTM test method D3493-06 is used for CDBP measurements disclosed herein with the modifications that 15 g of carbon black is crushed in the compression cylinder described in the procedures of the test method, and 10 g out of these crushed 15 g is then tested in an absorptometer used to determine the oil absorption number according to procedures of the ASTM test method, after which the results are scaled to 100 g of material.

In some embodiments, the carbon black particles have low levels of certain elements (such as calcium, potassium, sodium, and certain transition metals). These elements can react with the electrolyte or catalyze unwanted reactions with the electrolyte. It is believed that reducing the concentration(s) of these element(s) can reduce side reactions that cause self-discharge, generate gassing and degrade the cycle-life performance of the supercapacitors, particularly at elevated temperatures and high voltages. The carbon black particles can have, in any combination: less than or equal to about 100 ppm of calcium (e.g., less than or equal to about 80 ppm of calcium, less than or equal to about 60 ppm of calcium, less than or equal to about 40 ppm of calcium, or less than or equal to about 20 ppm of calcium); less than or equal to about 100 ppm of potassium (e.g., less than or equal to about 80 ppm of potassium, less than or equal to about 60 ppm of potassium, less than or equal to about 40 ppm of potassium, or less than or equal to about 20 ppm of potassium); less than or equal to about 100 ppm of sodium (e.g., less than or equal to about 80 ppm of sodium, less than or equal to about 60 ppm of sodium, less than or equal to about 40 ppm of sodium, or less than or equal to about 20 ppm of sodium); less than or equal to about 30 ppm of iron (e.g., less than or equal to about 20 ppm of iron, less than or equal to about 10 ppm of iron); less than or equal to about 2 ppm of nickel; less than or equal to about 2 ppm of copper; less than or equal to about 2 ppm of lead; less than or equal to about 2 ppm of manganese; less than or equal to about 2 ppm of zinc; and/or less than or equal to about 2 ppm of chromium. The concentrations of these elements can be determined using standard chemical analysis techniques.

The present carbon black particles, in some embodiments, have small D₅₀ and/or D95 agglomerate particle size distributions. It is believed that the small agglomerate particle size distributions enable and facilitate fabrication of tightly-packed, thin, and highly dense electrodes, which have lower ESRs than thicker electrodes. It is also easier to make dispersions using carbon black particles with small agglomerate particle size distributions. In some embodiments, the carbon black has a D₅₀ agglomerate particle size distribution ranging from about 0.1 to about 50 micrometers. The D₅₀ agglomerate particle size distributions can have or include, for example, one of the following ranges: from about 0.1 to about 40 micrometers, or from about 0.1 to about 30 micrometers, or from about 0.1 to about 20 micrometers, or from about 5 to about 50 micrometers, or from about 5 to about 40 micrometers, or from about 5 to about 30 micrometers, or from about 5 to about 20 micrometers, or from about 10 to about 50 micrometers, or from about 10 to about 40 micrometers, or from about 10 to about 30 micrometers, or from about 20 to about 50 micrometers, or from about 20 to about 40 micrometers, or from about 30 to about 50 micrometers. The D₅₀ agglomerate particle size distributions can have or include, for example, one of the following ranges: less than about 50 micrometers, or less than about 40 micrometers, or less than about 30 micrometers, or less than about 20 micrometers, or less than about 10 micrometers. In some embodiments, the carbon black has a D₉₅ agglomerate particle size distribution ranging from about 1 to about 250 micrometers. The D₉₅ agglomerate particle size distributions can have or include, for example, one of the following ranges: from about 1 to about 200 micrometers, or from about 1 to about 150 micrometers, or from about 1 to about 100 micrometers, or from about 1 to about 50 micrometers, or from about 50 to about 250 micrometers, or from about 50 to about 200 micrometers, or from about 50 to about 150 micrometers, or from about 50 to about 100 micrometers, or from about 100 to about 250 micrometers, or from about 100 to about 200 micrometers, or from about 100 to about 150 micrometers, or from about 150 to about 250 micrometers, or from about 150 to about 200 micrometers, or from about 200 to about 250 micrometers. The D₉₅ agglomerate particle size distributions can have or include, for example, one of the following ranges: less than about 250 micrometers, or less than about 200 micrometers, or less than about 150 micrometers, or less than about 100 micrometers, or less than about 50 micrometers. Particle size distribution is determined by hand shaking for 10 seconds 50 milligrams of the particles in a 50-gram of a solution of 40/10 ratio of deionized water/ethanol and 1 drop of Triton™ X100 surfactant (Sigma-Aldrich) using a Horiba LA-950V2 Particle Size Analyzer.

A simplified description of a present carbon black particle is an aggregate of a number of particulates, which are referred to as the primary particles (“primaries”). The size of primaries in a carbon black particle can vary, but production of carbon black with primaries of size (diameter) down to at least about 8 nm is feasible. The number of primaries in the aggregate can also vary, for example, from about one to about few tens or possibly hundreds, thus resulting in the carbon black particle size of up to about 500 nm. The mean particle size of the carbon black can be, for example, approximately 100 nm (0.1 micron). The number of primaries and the arrangement of them in the carbon black particle not only dictate the size of the carbon black particle but also the structure of the carbon black particle.

The average primary particle size is determined by ASTM D3849-04, the entirety of which is incorporated herein by reference, and can be, for example, less than about 50 nm, or less than about 30 nm, or less than about 20 nm, or less than about 10 nm. Carbon black aggregates are assemblies of primary carbon black particles that are fused at the contact points and cannot readily be separated by shearing. The average aggregate size of the carbon black particles may be extracted from TEM image analysis using the imaging technique described in ASTM D3849-04, the entirety of which is incorporated herein by reference. The carbon black particles can have an average aggregate size that is, for example, less than about 500 nm, or less than about 400 nm, or less than about 300 nm, or less than about 200 nm, or less than about 100 nm.

In certain embodiments, the carbon black particles can have one or more of the following properties:

(a) an average primary particle size of from about 8 nm to about 50 nm, or from about 8 nm to about 40 nm, or from about 8 nm to about 30 nm, or from about 8 nm to about 20 nm, or from about 10 nm to about 50 nm, or from about 10 to about 30 nm;

(b) an average aggregate particle size of from about 50 nm to about 500 nm, or from about 50 nm to about 400 nm, or from about 50 to about 300 nm, or from about 50 nm to about 250 nm, or from about 50 nm to about 200 nm, or from about 100 nm to about 500 nm, or from about 100 nm to about 400 nm, or from about 100 nm to about 300 nm, or from about 200 nm to about 500 nm, or from about 200 nm to about 400 nm. For example, the present carbon black particles can have an average size of primaries of from about 8 nm to about 50 nm, and an average aggregate particle size of carbon black particles of from about from about 50 nm to about 500 nm;

(c) an iodine number value (ASTM D1510) of from about 1000 to about 2200 mg/g, or from about 1200 to about 2000 mg/g, or from about 1500 to about 1900 mg/g, or from about 1690 to about 1710 mg/g, or from about 1695 to about 1700 mg/g;

(d) an ash percent (ASTM D1506) of less than about 0.5 wt % (e.g., from 0 to about 0.5 wt %, or from about 0 to about 0.3 wt %, or from about 0% to about 0.1 wt %, or less than about 0.3 wt % or less than about 0.1 wt %); and/or

(e) a pH of about 3 to about 7 (e.g., from about 3 to about 6).

The present carbon black particles can have, for example, one or more of these properties (a)-(e). For instance, the carbon black particles can have at least one, two, three, four, or five of these properties. The carbon black particles can have any combination of the properties (a)-(e).

In some embodiments, the present carbon black particles can be made by treating starting, or “base,” carbon black particles having high surface areas and/or low structures to form treated carbon black particles having one or more concentration levels of the elements described herein (e.g., less than or equal to about 100 ppm of calcium, sodium and/or potassium). Methods of making the base carbon black particles are described, for example, in U.S. Pat. No. 8,895,142, hereby incorporated by reference in its entirety. In some embodiments, treating the base carbon black particles includes contacting or extracting the base particles with an acid until particles have one or more desired concentration levels of the elements described herein. The acid can be, for example, hydrochloric acid, nitric acid, citric acid, oxalic acid, formic acid, and/or acetic acid. The treatment time, which can range, for example, from one minute to one hour, depends on, for example, the size of the base carbon black particles, the concentration of the acid, the temperature of the acid, etc. After treatment, the present carbon black particles can be dried.

In some embodiments, the particle size distribution of the treated carbon black particles is then reduced, for example, to enable fabrication of electrodes with high density. The particle size can be reduced, for example, by grinding, milling, sonication, and other known methods.

The present carbon black particles can be in the form of a powder or finely divided form. The present carbon black particles also can be, for example, pelletized, agglomerated, or mixed with any other substance, such as particles, liquids, solids, polymers, or other materials. Catalyzed forms of the present carbon black particles also can be provided.

Electrode 12 and/or 13 can include the present carbon black particles, which can be present alone or in combination with other carbon black particles that are within or outside one or more of the property specifications identified herein. In some embodiments, electrode 12 and/or 13 further contains other materials, such as activated carbon (or other large porous particles), a polymer (such as a polymer binder, such as a fluorinated polymer, such as poly(vinylidene fluoride-co-chlorotrifluoroethylene) co-polymer or similar polymers). Larger porous particles are described as being larger than about 2 microns and having a porosity such that the surface area is greater than about 1,000 m²/g. The porous particles that can be contained in the electrode are not specifically limited and can have electronic conductivity contributing to electric charge and discharge. An example of the applicable porous particles is granular or fibrous activated carbon that has been subjected to activation treatment. This type of activated carbon includes phenol based and coconut-shell based activated carbon. When any activated carbon (or other porous particle other than the carbon black of the present invention) is used with the carbon black of the present invention in the porous body layer, any weight ratio of the carbon black to activated carbon can be used, such as, but not limited to, weight ratios of (carbon black:activated carbon) from about 99:1 to about 1:99; or from about 90:10 to about 10:90; or from about 90:5 to about 15:85; or from about 90:10 to about 20:80; or from about 85:10 to about 25:75; or from about 80:20 to about 30:70; or from about 75:25 to about 35:65; or from about 70:30 to about 40:60; or from about 65:35 to about 45:55; or from about 60:40 to about 50:50; and the like. As an option, for example, less than about 50 wt % of activated carbon is present in the electrode (e.g., less than about 40 wt %, or less than about 30 wt %, or less than about 20 wt %, or less than about 10 wt %, or less than about 5 wt %, or from about 0.5 wt % to about 5 wt %, of activated carbon is present).

In certain supercapacitors, electrodes 12 and/or 13 have more activated carbon than carbon black particles. In such embodiments, since the activated carbon is typically less electronically conductive than the carbon black particles, the higher the concentration of carbon black particles, the more electronically conductive the electrodes 12 and/or 13. But the carbon black particles typically have lower BET surface areas than the activated carbon and do not provide significant double-layer capacitance. As a result, the weight fraction of carbon black particles is reducing the gravimetric capacitance of an electrode having 100% activated carbon. In some embodiments, the ratio of carbon black particles to activated carbon ranges from about 1:99 (i.e., 1%) to about 15:85 (i.e., 15%) by weight. The ratio of carbon black particles to activated carbon can have or include, for example, one of the following ranges, by weight: about 1:99 to about 10:90, or about 1:99 to about 5:95, or about 5:95 to about 15:85, or about 5:95 to about 10:90, or about 10:90 to about 15:85. Other ranges within or outside of these ranges are possible.

In some embodiments, the activated carbon has a high surface area to provide high double layer capacitance. The nitrogen BET surface area of the activated carbon can have or include, for example, one of the following ranges: from about 1,000 to about 2,500 m²/g, or from about 1,000 to about 2,250 m²/g, or from about 1,000 to about 2,000 m²/g, or from about 1,000 to about 1,500 m²/g, or from about 1,000 to about 1,250 m²/g, or from about 1,250 to about 2,500 m²/g, or from about 1,250 to about 2,250 m²/g, or from about 1,250 to about 2,000 m²/g, or from about 1,250 to about 1,750 m²/g, or about 1,250 to about 1,500 m²/g, or about 1,500 to about 2,500 m²/g, or from about 1,500 to about 2,250 m²/g, or from about 1,500 to about 2,000 m²/g, or from about 1,500 to about 1,750 m²/g, or from about 1,750 to about 2,500 m²/g, or from about 1,750 to about 2,250 m²/g, or from about 1,750 to about 2,000 m²/g, or about 2,000 to about 2,500 m²/g, or about 2,000 to about 2,250 m²/g. Other ranges within or outside of these ranges are possible.

As with the present carbon black particles, the activated carbon can have low levels of certain elements (such as calcium, potassium, sodium, and certain transition metals) to reduce undesirable side reactions as discussed above. The activated carbon can have, in any combination: less than or equal to about 100 ppm of calcium (e.g., less than or equal to about 80 ppm of calcium, less than or equal to about 60 ppm of calcium, less than or equal to about 40 ppm of calcium, or less than or equal to about 20 ppm of calcium); less than or equal to about 100 ppm of potassium (e.g., less than or equal to about 80 ppm of potassium, less than or equal to about 60 ppm of potassium, less than or equal to about 40 ppm of potassium, or less than or equal to about 20 ppm of potassium); less than or equal to about 100 ppm of sodium (e.g., less than or equal to about 80 ppm of sodium, less than or equal to about 60 ppm of sodium, less than or equal to about 40 ppm of sodium, or less than or equal to about 20 ppm of sodium); less than or equal to about 30 ppm of iron (e.g., less than or equal to about 20 ppm of iron, less than or equal to about 10 ppm of iron); less than or equal to about 2 ppm of nickel; less than or equal to about 2 ppm of copper; less than or equal to about 2 ppm of lead; less than or equal to about 2 ppm of manganese; less than or equal to about 2 ppm of zinc; and/or less than or equal to about 2 ppm of chromium.

In certain embodiments, the activated carbon typically has high pore volume and/or microporosity. The activated carbon can have a pore volume equal to or greater than about 0.7 cm³/gram, for example, equal to or greater than about 1.0 cm³/gram, or equal to or greater than about 1.5 cm³/gram. Alternatively or additionally, of its total pore volume, the activated carbon can have a microporosity (i.e., percentage of micropores (<2.5 nm)) equal to or greater than 60%, for example, equal to or greater than 70%, or equal to or greater than 80%, or equal to or greater than 90%.

Examples of activated carbon include commercially available products, such as those available from Cabot Norit Activated Carbon and Kuraray Co. Ltd. Examples of specific activated carbon include YP-17, YP-50F and YP-80F grades from Kuraray.

Electrode 12 and/or 13 can consist of the carbon black particles alone or optionally with activated carbon as indicated above, and can have a thin thickness, which is quite advantageous for purposes of the size of the overall supercapacitor. For instance, the porous body layer can have a thickness of from about 10 microns or less, or from about 5 microns or less; or from about 50 nm to about 10 microns; or from about 100 nm to about 9 microns; or from about 110 nm to about 8 microns; or from about 120 nm to about 7 microns; or from about 130 nm to about 5 microns. Additionally, electrode 12 and/or 13 can be up to about 3 mm, or up to about 2 mm, thick. Carbon black particles have an additional advantage over activated carbon electrode applications where a continuous, open network can form due to the structure of the carbon black particles. Due to this open framework, ions can move to surfaces within the porous body layer much more quickly than if the porous body layer were comprised of only activated carbon where the ions would have to diffuse into the about 2 to about 20 micron sized activated carbon particles.

In some embodiments, an EDLC have at least two electrodes, each of the electrodes being in contact or adjacent to a current collector, and each electrode being separated by a separator element. When there is more than one electrode, the electrodes can both contain a present carbon black particles or just one of the electrodes can contain the present carbon black particles. Further, each of the electrodes can contain the same or different carbon black particles described herein or each electrode can contain the same or different overall combinations of carbon black particles, polymer binder, optional activated carbon, or other ingredients.

As an example, a capacitor can have at least two electrodes, wherein at least one electrode has the present carbon black particles present and also at least one ionically conductive layer in contact with the electrode layers to serve as a separator and at least one electrolyte.

The present carbon black particles are electrically conductive carbon black particles so an electrode containing the particles has or can have electronic conductivity. The electrode is in contact with a current collector. The electrode can be formed by applying a liquid containing the present carbon black particles and, optionally, other conductive particles, and a binder, which is able to bind the particles with each other. The content of the binder in the electrode can be, for example, in the range of from about 0.5% by mass to about 15% by mass, or from about 1% by mass to about 15% by mass, or higher. Other amounts can be used, wherein this percent is based on the total weight of the porous body layer.

Additional information on the materials and constructions that can be used in EDLC 10 and other capacitors include the following.

A capacitor can include a pair of polarized electrodes with surfaces confronting each other. The capacitor also includes a pair of electrically conductive layers which are formed respectively on the other surfaces of the electrode bodies of the polarized electrodes. The polarized electrodes may be housed in an annular gasket which is made of electrically nonconductive rubber or synthetic resin. The polarized electrodes are separated from one another by a separator disposed therebetween. The capacitor can further include a pair of current collectors disposed respectively on the outer surfaces of the electrically conductive layers on the polarized electrodes.

The current collector in EDLC 10, for example, can be, for example, a metal foil such as aluminum foil. The metallic foil can be prepared by etching or by rolling using conventional techniques to prepare current collectors. Other current collectors, for instance, a carbon sheet or composite, non-porous metal or conductive polymers, can be used. The current collector can also comprise a metal, such as aluminum, that is deposited onto a carbon sheet, such as an extruded carbon black sheet, by various kinds of physical or chemical vapor depositions, for instance thermal evaporation of aluminum onto a carbon sheet. The thickness of the collector can be generally any suitable thickness, such as from about 5 microns to about 100 microns, such as from about 10 microns to about 100 microns, such as from about 20 to about 50 microns, or from about 25 to about 40 microns, or other thickness values.

Any organic or aqueous electrolytes can be used with the present carbon black electrodes. For instance, such organic electrolyte salts as triethylmethyl ammonium tetrafluoroborate (C₂H)₃CH₃NBF₄, tetraethyl ammonium tetrafluoroborate (C₂H₅)₄NBF₄, often abbreviated as TEMABF₄ and TEABF₄ respectively, or other salts in a propylene carbonate (PC, 1,2-propanediol cyclic carbonate), solvent, which has molecular formula C₄H₆O₃, or an acetonitrile (AN) solvent, which has molecular formula CH₃CN, or any other appropriate solvents can be used as organic electrolyte. Aqueous electrolytes can be for example H₂SO₄, KOH or other chemical solutions. The electrolyte can have any appropriate molarity.

A separator, such as a conventional separator, can also be used, for example, to separate two electrodes from each other. Examples of separators include, but are not limited to, porous paper, porous polyolefin films (e.g., porous polyethylene films, porous polypropylene films), porous fabrics, and the like. In an EDLC, a separator layer can have, for example, a thickness in the range of about 12.7 micrometers to about 254 micrometers, or other thickness values.

The capacitor can also have a bi-polar design.

The capacitors and components thereof that are described in U.S. Pat. Nos. 5,115,378; 5,581,438; 5,811,204; 5,585,999; and 5,260,855, which are incorporated in their entireties herein by reference, can be used in the present invention with the carbon black of the present invention. These patents generally describe conventional components, which can be used in the present invention with respect to electrolytes, containers to contain the capacitor, current collectors, and general structures of the electrodes and overall capacitor designs.

Any binder that is capable of binding the carbon black particles (and optionally other particles) with each other is appropriate for use in the electrode. Examples of binders include, but are not limited to, poly-tetrafluoroethylene (PTFE), polyvinylidenefluoride (PVDF), polyethylene (PE), polypropylene (PP), fluororubber, and the like. Examples of fluororubbers include, but are not limited to, fluororubber are vinylidenefluoride-hexafluoropropylene-based fluororubber (VDF-HFP-based fluororubber), vinylidenefluoride-hexafluoropropylene-tetrafluoroethylene-based fluororubber (VDF-HFP-TFE-based fluororubber), vinylidenefluoride-pentafluoropropylene-based fluororubber (VDF-PFP-based fluororubber), vinylidenefluoride-pentafluoropropylene-tetrafluoroethylene-based fluororubber (VDF-PFP-TFE-based fluororubber), vinylidenefluoride-perfluoromethylvinylether-tetrafluoroethylene-based fluororubber (VDF-PFMVE-TFE-based fluororubber), vinylidenefluoride-chlorotrifluoroethylene-based fluororubber (VDF-CTFE-based fluororubber). Among them, a fluororubber prepared by copolymerization of at least two kinds selected from VDF, HFP and TFE can be used, and a VDF-HFP-TFE-based fluororubber prepared by copolymerization of the above three kinds can be used.

The present invention accordingly, as an option, provides an electrode for an EDLC which can have an overall improved electrical conductivity and less unwanted side reactions compared to earlier devices. The electrode has more electrical contacts with the current collector by virtue of the small, high surface area carbon black particles. Further, the small, high surface area carbon black particles can pack together such that the apparent density is either only slightly affected in a negative fashion (e.g., about 10% or less decrease), not affected, or enhanced. Thus, the small, high surface area carbon black particles that pack in a tight fashion replace other conductive additives in that this material is now the small particle that fills the inter-particle voids of the larger porous particles. But the small, high surface area carbon black particles have the additional advantage that the packing density is increased such that the highly conductive, small, high surface area carbon black particles will not decrease the volumetric capacitance of the as made electrode. And the low levels of certain elements reduce unwanted side reactions to reduce the performance of the electrode.

If increased dispersability of the carbon black particles with a binder is desirable, the carbon black particles can have one or more chemical groups, such as organic groups attached to its surface (e.g., chemically attached, adsorbed, coated, or otherwise present). For example, the carbon black particles can have attached at least one organic group comprising an aromatic group and/or an alkyl group. The aromatic group or alkyl group can be directly attached to the carbon black particles (e.g., a carbon atom of the aromatic or alkyl group is attached (e.g., bonded) to the carbon black particles). Moreover, and although typically not preferred for a symmetric EDLC, the chemical groups on carbon black surface can allow the carbon black particles to be used in other configurations, such as for pseudo-capacitors. For instance, a fluoro group or fluoro-containing organic group can be attached to the carbon black particles, for instance, as described in U.S. Pat. No. 6,522,522. The chemical groups, as well as methods to attach these groups to the conventional carbon black, are described in the following U.S. patents and publications, which are all incorporated in their entirety by reference herein: U.S. Pat. Nos. 5,851,280; 5,837,045; 5,803,959; 5,672,198; 5,571,311; 5,630,868; 5,707,432; 5,554,739; 5,689,016; 5,713,988; WO 96/18688; WO 97/47697; and WO 97/47699. The organic groups, which can be attached onto the carbon black particles, can be electron donor and/or electron acceptor groups. Alternatively, the organic groups, which can be attached onto the carbon black particles can include electron donor and/or electron acceptor groups. Yet another possibility is that electron donor and/or electron acceptor groups can be associated with the carbon black surface as counter ions. The organic groups that are attached onto carbon black particles could be simple small molecules, oligomers, or polymers. Examples of such electron donor and acceptor groups include, but are not limited to, substituted or un-substituted quinones; organometallic groups, such as substituted or un-substituted metallocenes (e.g., ferrocenes); substituted or un-substituted thiophenes/furans/pyrroles/carbazoles; substituted or un-substituted tetrathiafulvalene; and/or substituted or unsubstituted aromatic amines, for example, tri-phenylamines. Examples of polymeric electron donor and acceptor groups include, but not limited to, polythiophenes, polyacetylenes, polyphenylenevinylenes, polyanilines, and poly vinylcarbazoles.

The organic groups which can be attached onto the carbon black can be at least one or more ionic or ionizable groups or both. Ionic or ionizable functional groups forming anions or anionic groups include, for example, acidic groups or salts of acidic groups. Examples of organic groups that are anionic in nature include, but are not limited to, —C₆H₄—COO⁻X⁺; —C₆H₄—SO₃⁻X⁺; —C₆H₄—(PO₃)₂⁻²X⁺; —C₆H₂—(COO⁻X⁺)₃; —C₆H₃—(CO⁻X⁺)₂; —(CH₂)₂—(COO⁻X⁺); —C₆H₄—(CH₂)₂—(COO⁻X⁺), wherein X⁻ is any cation such as Na⁺, H⁺, K⁺, NH₄⁺, Li⁺, Ca²⁺, Mg²⁺ and the like. As recognized by those skilled in the art, X⁺ may be formed in-situ as part of the manufacturing process or may be associated with the aromatic or alkyl group through a typical salt swap or ion-exchange process. Amine represents examples of ionizable functional groups that form cations or cationic groups. Quaternary ammonium groups, quaternary phosphonium groups and sulfonium groups also represent examples of cationic group. Examples of organic groups that are cationic in nature include, but are not limited to, —C₆H₄N(CH₃)₃⁺Y⁻, —C₆H₄COCH₂N(CH₃)₃⁺Y⁻, —C₆H₄(NC₅H₅)⁺Y⁻, —(C₅H₄N)C₂H₅⁺Y⁻, —(C₃H₅N₂)⁺Y⁻ (imidazoles), —(C₇H₇N₂)⁺Y⁻ (indazoles), —C₆H₄COCH₂(NC₅H₅)⁺Y⁻, —(C₅H₄N)CH₃⁺Y⁻, and —C₆H₄CH₂N(CH₃)₃⁺Y⁻, wherein Y⁻ is any halide or an anion such as RSO₃⁻, SO₄²⁻, PO₄³⁻, NO₃⁻, OH₃⁻, CH₃COO⁻ and the like; or combinations thereof, wherein R is an alkyl or aromatic group. As recognized by those skilled in the art, Y⁻ may be formed in-situ as part of the manufacturing process or may be associated with the aromatic or alkyl group through a typical salt swap or ion-exchange process.

Any physically allowable treatment level of chemical groups (e.g., organic groups) with the carbon black is generally permitted. The treatment level of chemical groups with the carbon black, which may be expressed in terms of μmol/m² of carbon, of the chemical group (e.g., organic group) on the carbon black can be, for example, from about 0.1 to about 10 μmol/m² or more.

The carbon black in the present electrodes can have one type of chemical group (e.g., organic group) attached or more than one type of chemical group attached to its surface. In other words, dual or multi-treated modified carbon black can be used. Also, a mixture of modified carbon blacks having different chemical groups attached can be used.

The electrode containing the carbon black and optionally other components can be formed, for example, by coating the current collector with a liquid dispersion containing these components as a dispersion formulation. Exemplary liquids include, but are not limited to, organic-based solvents, such as ketone-based solvents like methylethyl ketone or methylisobutyl ketone, and aqueous solvents. Other examples are water and N-methyl pyrollidone (NMP).

Generally, any dispersion formulations, containing the present carbon black particles, and dispersion preparation and processing, can be used as part of the electrode fabrication. The dispersion formulation can comprise several components: carbon black particles, binders, dispersing agents, rheology modifiers, solvents, etc. This dispersion formulation can be, for example, in slurry form. The temperature can be controlled during dispersion mixing to from 15 to 45° C. or other ranges. The mixing can be performed via a high shear process, etc., where the mixing device can be a rotor stator, horizontal mill, sonic horn, sonic bath, cowls blade, and the like. Any viscosity of the dispersion can be achieved by choosing the appropriate mass content of particle in the dispersion, and this viscosity is chosen based on the application method of the dispersion. Examples of the coating method include, for example, an extrusion-lamination method, doctor-blade method, gravure-coat method, reverse-coat method, applicator-coat method, and screen-printing method.

Still other embodiments are possible. For example, the supercapacitor can be a symmetric supercapacitor or have other configurations. Other devices that use the phenomenon of pseudocapacitance or use a hybrid design of a battery with capacitor can benefit as well from the utilization of these carbon black particles. With each of these types of capacitors, the present carbon black particles can be a part of one or more electrodes.

The various EDLC designs and materials set forth in U.S. Patent Application Publication Nos. 2002/0012224 and 2004/0085709, and U.S. Pat. Nos. 5,646,815, 6,804,108, and 7,236,349, can be used, for example, with the present carbon black particles, and these patents (and all other patents mentioned herein) and patent publication (and all other publications mentioned herein) are incorporated in their entireties by reference herein.

The present carbon black particles also can be used in other various energy storage devices, including, for example, the use as a conductive additive to electrodes in batteries, as a catalyst support in fuel cells, and the use in hybrid energy storage devices, which are devices (also known as asymmetric supercapacitors or hybrid battery/supercapacitors) that combine battery electrodes and EDLC electrodes in one cell. For instance, the hybrid lead-carbon energy storage devices employ lead-acid battery positive electrodes and supercapacitor negative electrodes as described in, for example, U.S. Pat. Nos. 6,466,429; 6,628,504; 6,706,079; 7,006,346; and 7,110,242.

### EXAMPLES

### Example 1

This example describes a process of treating (e.g., extracting) unpurified carbon black particles (CB) with hydrochloric acid to form purified carbon black particles (CB-A).

Seventy-five grams of commercially-available PBX® 51 carbon black particles (Cabot Corporation, US) were added to 675 g of a 0.25 wt % HCl aqueous solution with slow agitation to form a slurry. The slurry was heated to 80° C. and held for 1 hr. The slurry was then transferred hot to a Buchner funnel and dewatered. Three successive washes with 600 mL of 80° C. deionized water were added, followed by a neutralization wash with 150 mL of 0.3 wt % Na₂CO₃ at 80° C., and finally two additional 600 mL of 80° C. deionized water washes. The filter cake did not dry in between the washes, and the washes were added prior to any cracks forming in the cake. The cake was dried in an oven overnight at 110° C. under air. The final step was to reduce the particle size distribution to less than 20 micrometers with a single pass hammer mill.

### Example 2

This example describes a process of treating unpurified carbon black particles (CB) with citric acid to form purified carbon black particles (CB-B).

One hundred twenty-five grams of commercially-available PBX® 51 carbon black particles (Cabot Corporation, US) and 2,375 g of 0.1 wt % citric acid in deionized water were stirred together to wet out the particles. Using a Pall membrane diafiltration operation, recirculate until 5×2,500 g (5 volumes) of make up 0.1 wt % citric acid in deionized water at ambient temperature (˜25° C.) is fed while the membrane allows passage of the aqueous-salt mixture, and maintain a constant slurry volume in the system. Following the citric acid wash, use an additional 5×2,500 g wash volumes of deionized water and ensure the conductivity of the slurry is <250 μS. Dry the slurry in a spray dryer, approximately 200° C. inlet air, and 100° C. outlet air.

TABLE 1
Analytical Measurements for Examples 1 and 2

| | Unpurified | CB-A | CB-B |
|---|---|---|---|
| Measurement | CB | HCl Treatment | Citric Acid Diafiltration |
| % Ash | 1.56% | <0.05% | <0.05% |
| K (ppm) | 1330 | 33.5 | 39.8 |
| Ca (ppm) | 6120 | 59 | 70 |
| Na (ppm) | 20.4 | 3.5 | 0.9 |
| Fe (ppm) | 18.3 | 4.9 | 21.8 |
| Ni (ppm) | 2.6 | 1.0 | 2.1 |
| S (ppm) | 1630 | 815 | 580 |

### Example 3

This example describes a preparation of supercapacitor electrodes.

Steam-activated coconut-shell-based activated carbon (YP-17, Kuraray Chemicals Co., Japan) and various carbon black additives (CB, CB-A, and CB-B) were used to prepare supercapacitor electrodes. The mass ratio of carbon black additives to activated carbon (AC) was 9:1. Electrodes were prepared using 81:9:10 AC:CB:polyvinylidene difluoride (PVDF) binder formulations from 30 wt % solids slurry in N-methyl-2-pyrrolidone (NMP) solvent mixed for 20 minutes in a Thinky mixer. The PVDF binder was Kynar® HSV 900 PVDF from Arkema, dissolved at 10 wt % in NMP. The slurry was coated onto carbon-coated aluminum foil (15 μm in thickness) with an automatic film coater (MTI Corporation), and the resulting electrode sheet thickness was 130±15 μm (excluding the foil). The as-prepared electrode sheet was transferred to a mechanical convection oven (DKN 600, Yamato, Japan) operated at 85° C. to evaporate all the solvent, and then further dried in a vacuum oven (MTI Corporation) at 100° C. overnight.

### Example 4

This example describes conductivity measurements of supercapacitor electrodes.

A through-plane resistivity setup was used to measure the volumetric resistance of supercapacitor electrodes. The electrode thickness was measured by a drop gauge (Mitutoyo, Japan), which was modified to allow resistivity measurements through the electrode, via a Keithley 4010C SourceMeter® source measure unit instrument. A two-electrode configuration in a standard CR2032 coin cell (diameter 20 mm, height 3.2 mm) was employed to conduct electrochemical measurements. Electrode discs with diameter of 15 mm were punched out with heavy duty disc cutter (MTI Corporation) and weighed with a high precision digital balance (0.01 mg readability, XS205, Mettler Toledo), followed by a calendering step with a gap setting at scale 5 on the calendering roller (MTI Corporation).

TABLE 2
Characterization of Supercapacitor Electrodes

| | Electrode density | Through-plane | Conductivity |
|---|---|---|---|
| | (g/cc) | resistance (Ω) | (mS/cm) |
| YP-17 AC only | 0.8 | 12.5 | 2.52 |
| YP-17 AC + | 0.79 | 11.2 | 2.76 |
| Denka Black (AB) | | | |
| YP-17 AC + | 0.79 | 9.5 | 3.26 |
| untreated CB | | | |
| YP-17 AC + CB-A | 0.8 | 9.1 | 3.43 |
| YP-17 AC + CB-B | 0.8 | 8.8 | 3.58 |

### Example 5

This example describes capacitance measurements of supercapacitor electrodes.

Supercapacitor working electrodes and counter electrodes were made from the same carbon-base slurry, had similar mass, and were separated by a glass-fiber filter (GF/C, Whatman, US). The electrolyte solution was made by dissolving 1 M tetraethylammonium tetrafluoroborate (TEA-BF4, Sigma Aldrich, US) in acetonitrile (ACN, 99% Sigma Aldrich, US). The cell assembly was constructed in an argon gas glove box (MBraun, US) with moisture and oxygen content less than 1 ppm. Cyclic voltammetry (CV) measurements were performed on a potentiostat (Parstat 2273, Princeton Applied Research, US) with scan rate of 10 mV/s in the potential window from 0 to 3.0 V. The galvanostatic charge-discharge cycling was carried out on a MTI 8-channel battery tester at constant current of 10 mA for 10,000 cycles.

FIG. 2 shows CV curves of electrodes including YP-17 AC only; YP-17 AC+Denka Black acetylene black (AB) (Denka Co., Japan); YP-17 AC+CB; YP-17 AC+CB-A; and YP-17 AC+CB-B in 1.5 M TEA-BF4/ACN electrolyte solution. The CV curves are all comparable in their rectangular shapes, which demonstrate characteristic double-layer capacitance. The YP-17 AC only electrode displays a much more resistive behavior than the electrodes with carbon additives CB, CB-A and CB-B. The corresponding specific capacitances of electrodes containing CB-A and CB-B from the CV curves are higher than that of electrodes made with YP-17 AC only. It is believed that the high surface areas of the carbon black additives provide significant double-layer capacitance. The CV curves of the electrodes containing three types of carbon black additives are rather similar, with YP-17+CB-A being the least resistive and yielding the highest specific capacitance.

TABLE 3
Characterization of Supercapacitor Electrodes

| | Electrode | Carbon | Specific |
|---|---|---|---|
| | density | loading | capacitance |
| | (g/cc) | (mg/cm²) | @ 1.5 V (F/g) |
| YP-17 AC only | 0.8 | 7.59 | 78.9 |
| YP-17 AC + Denka Black (AB) | 0.79 | 7.37 | 65.6 |
| YP-17 AC + untreated CB | 0.79 | 7.88 | 76.0 |
| YP-17 AC + CB-A | 0.8 | 7.4 | 82.1 |
| YP-17 AC + CB-B | 0.8 | 7.98 | 87.8 |

### Example 6

This example describes characterization of the cycle life of supercapacitor electrodes.

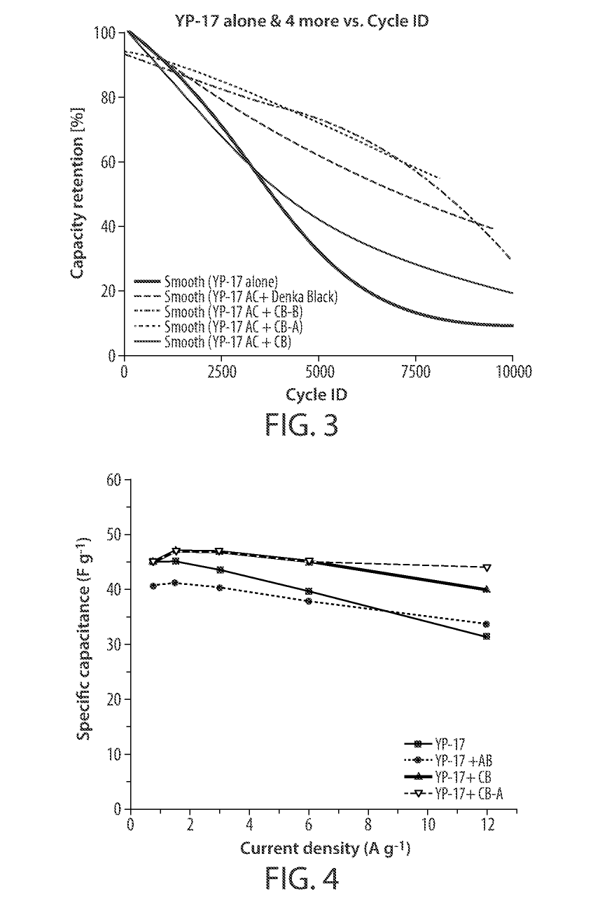

The cycling performance of the electrodes was examined at a current density of 5.65 A cm-2. FIG. 3 shows the capacity retention rate of specific capacitance as a function of cycle number (10,000 cycles). The cell made with YP-17 AC only electrodes exhibited a quick drop in the discharge capacitance up to about 6,500 cycles and then the decay rate levels out. In comparison, a much better capacity retention rate can be observed from the cells made with YP-17 AC+CB-A and YP-17 AC+CB-B electrodes. However, the cell made with YP-17 AC+CB electrodes shows only a slight improvement in capacity retention over the cell made with YP-17 AC only electrodes. The gained benefit of acid washing to remove impurities in the carbon conductive additives is substantial.

### Example 7

This example describes characterization of the C-rate capability and impedance of supercapacitor electrodes.

FIG. 4 is a plot of specific capacitance (F/g) vs. current density (A/g) for supercapacitor electrodes with different compositions. The rate capability study was conducted with a Maccor 4000 series battery cycler using currents ranging from 5.66 to 362.20 mA cm⁻². The capacitance was obtained by the equation below:

$$C = \frac{i}{s \cdot m}$$

where C is the specific capacitance (F g⁻¹), i (A) is the applied current, s is the slope of the discharge curve, and m is the mass loading of the active material on the electrode. As shown, compared with cells made with YP-17 AC only electrodes, cells with YP-17 AC+Denka Black electrodes, YP-17 AC+CB electrodes, and YP-17 AC+CB-A electrodes exhibited significantly improved specific capacitance.

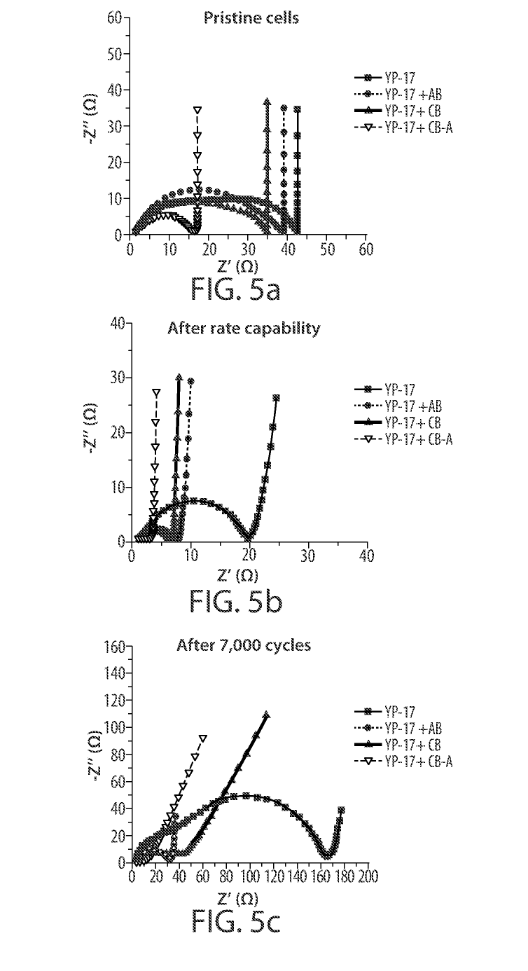

FIGS. 5(a), 5(b) and 5(c) are Nyquist plots of two-electrode EDLCs with different compositions in the frequency range between 1 MHz and 10 mHz for pristine cells, cells after the rate capability test, and cells after long cycling, respectively. Electrochemical impedance spectroscopy measurements were carried out using a Parstat 2273 potentiostat (Princeton Applied Research, USA). FIGS. 5(a), 5(b) and 5(c) show the Nyquist plots for supercapacitor cells made with different carbon composite electrodes before and after galvanostatic charge/discharge cycling. A typical plot includes an intercept on the Z′ axis in the high-frequency region, a depressed semicircle in the high-intermediate frequency region, and an inclined line in the low-frequency region. The intersection between the Nyquist plot and the real part axis corresponds to the equivalent series resistance of the cell components and the electrolyte, which is in the range of 0.5-1Ω for all the cells. The semicircle primarily represents the charge-transfer resistance at the interface between the electrode and electrolyte. The inclined line reflects the diffusion of ions into the bulk of the electrode, which is known as Warburg diffusion.

In FIG. 5(a), cells made with YP-17 AC+CB-A show the least charge-transfer resistance, while the charge-transfer resistances of other cells are in a higher range. After the rate capability test (FIG. 5(b)), it can be seen that the charge-transfer resistances of cells made with electrodes containing carbon black conductive additives are reduced considerably. However, the charge-transfer resistance of the cells having electrodes having only activated carbon decreases in a lesser extent. The changes in the Nyquist plots after 7000 cycles of galvanostatic charge/discharge can be well correlated to the capacitance fading behaviors presented in FIG. 5(c). Cells made with electrodes containing no conductive additive show the largest increase in charge-transfer resistance, and they suffer the most significant capacitance decay at the end of cycling. The second worst cycling performance belongs to cells having YP-17 AC+untreated CB electrodes which show the second largest resistance growth. The charge-transfer resistance only increases moderately for the cells made with YP-17 AC+Denka AB electrodes. The cells made with YP-17 AC+CB-A electrodes have the smallest increase in charge-transfer resistance over the repeat cycling. These results demonstrate the benefits of carbon black with high specific surface area and reduced amount of impurities to the active carbon electrodes used in supercapacitor applications.

The use of the terms “a” and “an” and “the” is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All publications, applications, and patents referred to herein are incorporated by reference in their entirety.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A supercapacitor, comprising:
an electrode comprising (a) activated carbon and (b) carbon black particles comprising less than or equal to about 100 ppm of calcium.

2. The supercapacitor of claim 1, wherein the carbon black particles further comprise less than or equal to about 100 ppm of potassium and/or less than or equal to about 100 ppm of sodium.

3. The supercapacitor of claim 1, wherein the carbon black particles comprise one or more of the following characteristics:
(a) less than or equal to about 30 ppm of iron;
(b) less than or equal to about 2 ppm of nickel;
(c) less than or equal to about 2 ppm of copper;
(d) less than or equal to about 2 ppm of lead; and/or
(e) less than or equal to about 2 ppm of manganese.

4. The supercapacitor of claim 1, wherein the carbon black particles have a Brunauer, Emmett and Teller (BET) surface area ranging from about 600 m²/g to about 2,100 m²/g.

5. (canceled)

6. The supercapacitor of claim 1, wherein the carbon black particles have a crushed dibutyl phthalate (CDBP) value ranging from about 50 mL/100 g to about 300 mL/100 g.

7. (canceled)

8. The supercapacitor of claim 1, wherein the carbon black particles have a D₅₀ agglomerate particle size distribution of less than about 50 micrometers, and/or a D₉₅ agglomerate particle size distribution of less than about 250 micrometers.

9. The supercapacitor of claim 1, wherein the carbon black particles comprise one or more of the following characteristics:
(a) an average primary particle size of from about 8 nm to about 50 nm;
(b) an average aggregate particle size of from about 50 nm to about 500 nm;
(c) an iodine number value of from about 1,000 mg/g to about 2,200 mg/g;
(d) an ash content of less than about 0.5 wt %; and/or
(e) a pH of about 3 to about 7.

10. (canceled)

11. The supercapacitor of claim 1, wherein the activated carbon has a BET surface area ranging from about 1,000 m²/g to about 2,500 m²/g.

12. The supercapacitor of claim 1, wherein the activated carbon has pore volume equal to or greater than about 0.7 cm³/gram and/or a microporosity equal to or greater than 60%.

13. The supercapacitor of claim 1, wherein the activated carbon comprises one or more of the following characteristics:
less than or equal to about 100 ppm of calcium;
less than or equal to about 100 ppm of potassium;
less than or equal to about 100 ppm of sodium;
(d) less than or equal to about 30 ppm of iron;
(e) less than or equal to about 2 ppm of nickel;
(f) less than or equal to about 2 ppm of copper;
(g) less than or equal to about 2 ppm of lead; and/or
(h) less than or equal to about 2 ppm of manganese.

14. (canceled)

15. A method, comprising:
treating base carbon black particles to form treated carbon black particles comprising less than or equal to about 100 ppm of calcium; and
using the treated carbon black particles to form an electrode of a supercapacitor.

16. (canceled)

17. (canceled)

18. The method of claim 15, wherein treating the base carbon black particles comprises contacting the base carbon black particles with an acid.

19-31. (canceled)

32. Carbon black particles having a Brunauer, Emmett and Teller (BET) surface area ranging from about 600 m²/g to about 2,100 m²/g, and comprising less than or equal to about 100 ppm of calcium.

33. The carbon black particles of claim 32, further comprising less than or equal to about 100 ppm of potassium and/or less than or equal to about 100 ppm of sodium.

34. The carbon black particles of claim 32, further comprising one or more of the following characteristics:
less than or equal to about 30 ppm of iron;
less than or equal to about 2 ppm of nickel;
less than or equal to about 2 ppm of copper;
less than or equal to about 2 ppm of lead; and/or
less than or equal to about 2 ppm of manganese.

35-39. (canceled)
